(19) United States
(12) Patent Application Publication
(10) Pub. No.: US 2013/0018490 A1
(43) Pub. Date: Jan. 17, 2013

(54) Web-Based Operator Control Interface to Generator Control Systems

(71) Applicants: Paul Oliver Caffrey, Roanoke, VA (US); Jordan Brantley Casteel, Roanoke, VA (US); Dhanashree Sadanand Damodar, Mumbai (IN); Douglas Gregg Fowley, Roanoke, VA (US); Roy Jackson, Roanoke, VA (US); William Robert Pearson, Roanoke, VA (US)

(72) Inventors: Paul Oliver Caffrey, Roanoke, VA (US); Jordan Brantley Casteel, Roanoke, VA (US); Dhanashree Sadanand Damodar, Mumbai (IN); Douglas Gregg Fowley, Roanoke, VA (US); Roy Jackson, Roanoke, VA (US); William Robert Pearson, Roanoke, VA (US)

(73) Assignee: GENERAL ELECTRIC COMPANY, Schenectady, NY (US)

(21) Appl. No.: 13/180,385

(22) Filed: Jul. 11, 2011

(51) Int. Cl. G06F 1/26; G06F 3/048; G05B 15/00

(52) U.S. Cl. 700/83; 700/287

(57) ABSTRACT

A web-based operator control interface system can include an operator interface section including a web browser application, a generator exciter section or a static starter section coupled to the operator interface section, a generator coupled to the generator exciter section and a web server application configured to receive processing requests from the web browser application, and further configured to internally process real-time generator functions.

### BACKGROUND OF THE INVENTION

The subject matter disclosed herein relates to generator control systems and more particularly to a web-based operator control interface for generator control systems.

Generator control systems typically include a generator coupled to an exciter and static starter to provide excitation current to start-up and operate the generator. Generator control systems can further include a computer and human local operator interface to allow an operator to configure and trouble shoot the generator control system. Typical local operator interfaces implement a custom hardware platform with custom third party software and communicate between the computer and the control system components via an RS232 serial link. This approach can limit installation flexibility and ability to easily make enhancements, and require rework to address component obsolescence issues. In addition, embedded controllers for generator systems can be charged with subservient tasks, increase overhead and can interfere with real-time operational requirements of the generator system.

### BRIEF DESCRIPTION OF THE INVENTION

According to one aspect of the invention, a web-based operator control interface system is described. The system can include an operator interface section including a web browser application, a generator exciter section or a static starter section coupled to the operator interface section, a generator coupled to the generator exciter section and a web server application configured to receive processing requests from the web browser application, and further configured to internally process real-time generator functions.

According to another aspect of the invention, a web-based operator control interface method for a generator system is described. The method can include receiving requests from a web browser application residing on an operator interface section of the generator system, delegating generation of the requests for the web browser application via common gateway interface calls, internally processing requests in an embedded controller, related to real-time generator functions of the generator system via internal common gateway interface functions and delegating non-real time tasks to the operator interface section.

According to yet another aspect of the invention, a computer program product including a non-transitory computer readable medium storing instructions for causing a computer to implement a web-based operator control interface method for a generator system is described. The method can include receiving requests from a web browser application residing on an operator interface section of the generator system, delegating generation of the requests for the web browser application via common gateway interface calls, internally processing requests in an embedded controller, related to real-time generator functions of the generator system via internal common gateway interface functions and delegating non-real time tasks to the operator interface section.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 illustrates a block diagram of an exemplary web-based operator control interface system to generator control systems.

FIG. 2 illustrates system level diagram of a web server application.

FIG. 3 illustrates a system level diagram of a web server.

FIG. 4 illustrates an exemplary embodiment of a system for implementing a web-based operator control interface to generator control systems.

The detailed description explains embodiments of the invention, together with advantages and features, by way of example with reference to the drawings.

### DETAILED DESCRIPTION OF THE INVENTION

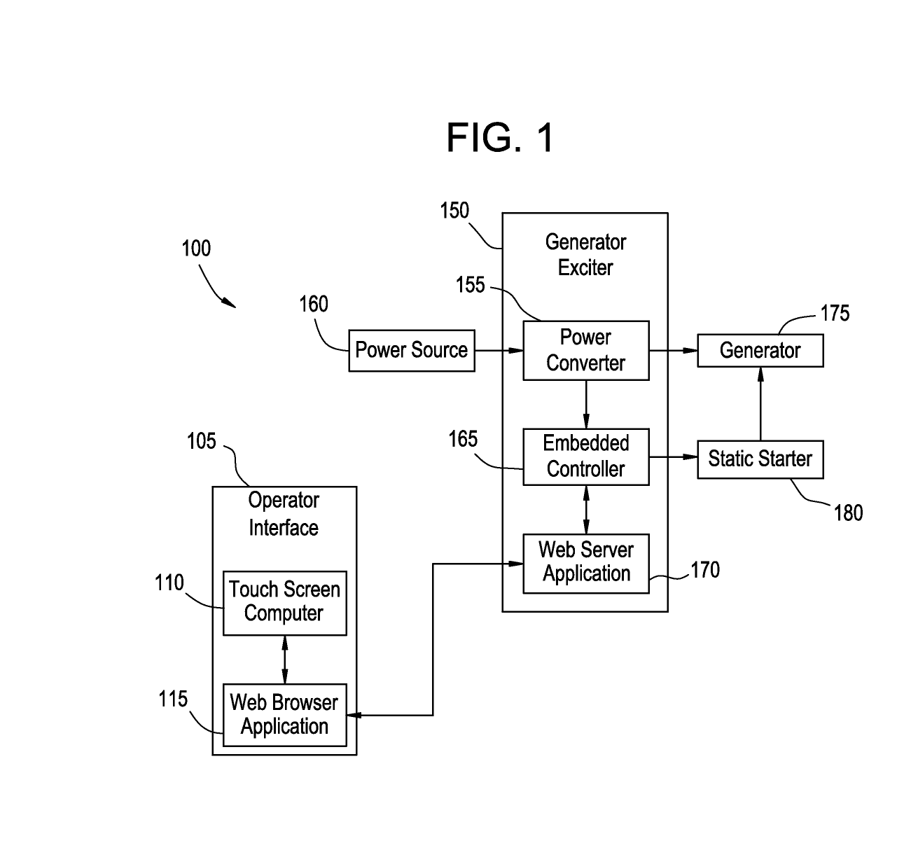

FIG. 1 illustrates a block diagram of an exemplary web-based operator control interface system 100 to generator control systems. The exemplary systems and methods described herein are described as web-based. It will be appreciated that the other electronic communications infrastructures local to the plant where the generator equipment is installed can include any suitable local area network, a wide area network, or the global world wide web. In exemplary embodiments, the system 100 can include an operator interface section 105, a generator exciter or static starter section 150 operatively coupled to the operator interface section 105 and a generator 175 operatively coupled to the generator exciter section 150.

In exemplary embodiments, the operator interface 105 is an interactive physical interface between an operator and electrical or mechanical equipment such as an embedded controller, which can provide features such as control inputs, configuration, status feedback, and diagnostic information. The operator interface 105 can therefore include a computer 110 and a web browser application 115 residing on the computer 110. In exemplary embodiments, the computer 110 can include a touch screen that can include a graphical user interface (GUI). For illustrative purposes, the computer 110 can therefore be a touch screen computer. As such, when buttons are pressed on the touch screen, signals are generated that send commands to the computer 110. The web browser application 115 can be a software application that interfaces between an operator and a web server using a HyperText Markup Language (HTML) communications protocol.

In exemplary embodiments, the generator exciter system 150 supplies and controls power to a generator field supplied to the generator 175, such that generator output is regulated. The generator exciter system 150 can include a fully static power converter, or a static regulator and a rotating exciter that amplifies the regulator output before applying it to the generator field. In exemplary embodiments, the generator exciter system 150 therefore includes a power converter 155 that can be a solid state device for supplying a large ac or dc load in a regulated manner from one or more unregulated alternating current (AC) or direct current (DC) power sources 160. The power converter 155 can be configured to provide a variable DC voltage output from either an AC or DC power source. The generator exciter system 150 can further include an embedded controller 165 that can be a processor-based control system including various I/O interfaces, for controlling a system such as the power converter, an exciter, or a static starter 180. In exemplary embodiments, the static starter 180 is a system for initially spinning the generator 175 up to a suitable speed from standstill by operating it as a synchronous motor. As such, the embedded controller 165 is operatively coupled to the power converter 155, and the static starter 180. The generator exciter system 150 can further include a web server application 170, which can be a software application configured to provide data in response to communication requests from remote web client applications, such as through the operator interface 105, connected via an interface such as Ethernet via the HTML communications protocol.

In exemplary embodiments, the embedded controller 165 can be a simplex controller or a redundant controller in which one controller is an active controller and one or more additional controllers are available to become active if the active controller fails. The web server application 170 can therefore reside on one or more controllers redundantly. In exemplary embodiments, in the event of a failure of an active controller, the web server application 170 as well as the web browser application 115 on the operator interface section 105 automatically re-establishes communication with a new active controller.

In exemplary embodiments, the generator 175 is a rotating synchronous machine including a rotating field winding for producing a magnetic field and non-rotating stator windings for converting steam, hydro, or combustion energy to electrical energy. It will be appreciated that the generator can be any machine in various exemplary embodiments.

As such, the web server application 170 is a web-based interface between a local operator station or human-machine interface (HMI), (e.g., the operator interface 105) and generator control systems that generally include components such as the generator exciter 150, the generator 175 the static starter 180, and any other static or rotating field exciters. The web server application 170 can be portable and compatible as systems are upgraded. In exemplary embodiments, the embedded controller 165 can include any web server, which is a component of the web server application 170, which runs in the background. It will be appreciated that the embedded controller 165 (including the web application 170) meets real-time operational requirements of the excitation or static starter systems (e.g., the generator exciter 150 and the static starter 180), and this function must not be compromised by subservient tasks such as the web server.

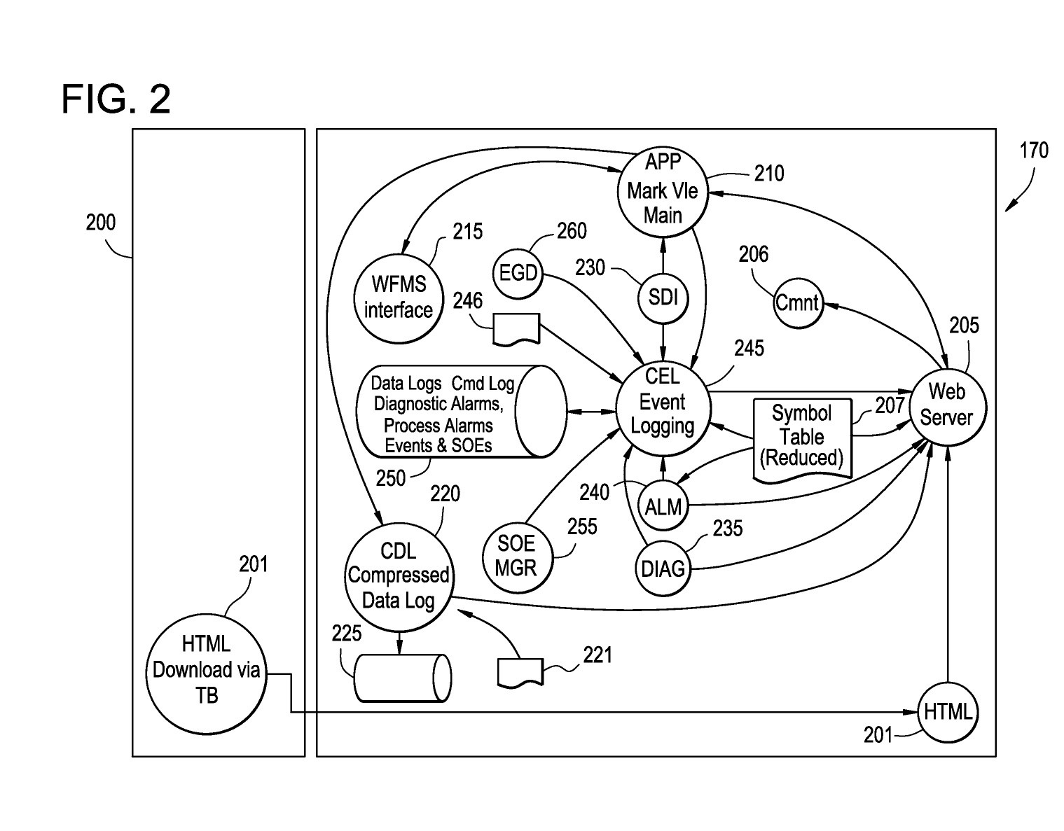

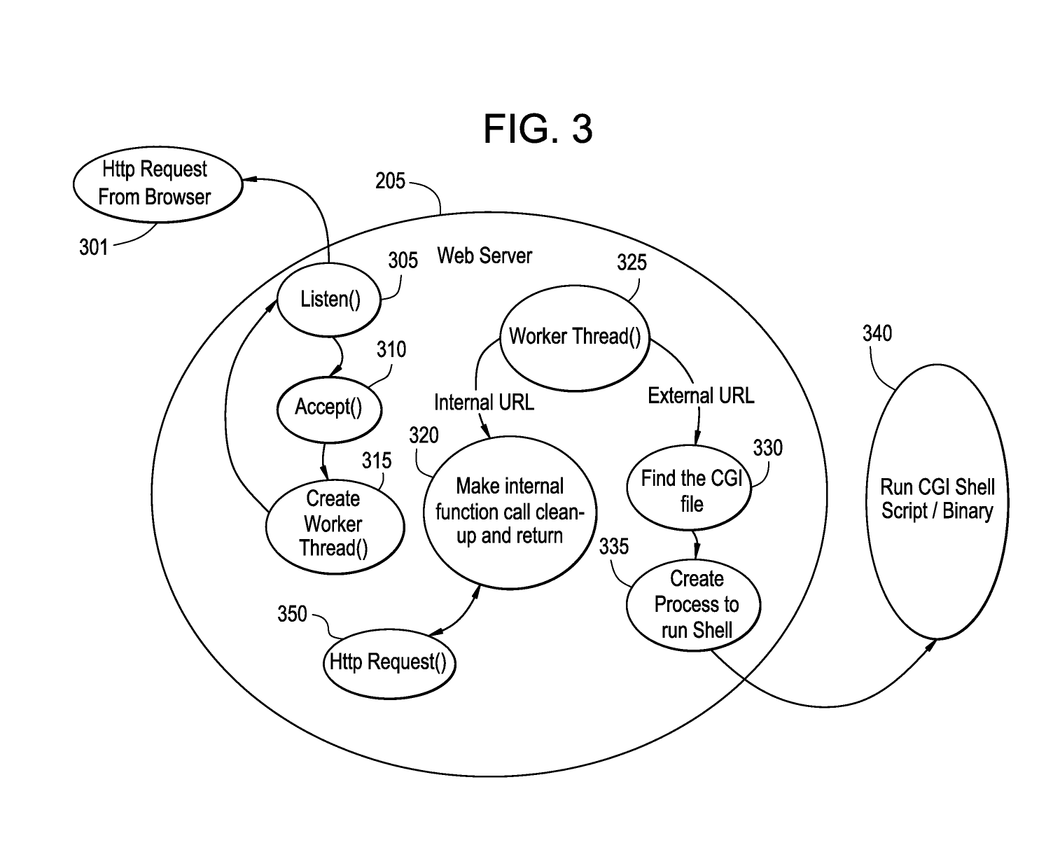

FIG. 2 illustrates system level diagram of the web server application 170 of FIG. 1. The web server application 170 can be coupled to a supervisory control and data acquisition (SCADA) system 200. SCADA components include any industrial control systems having computer systems that monitor and control industrial, infrastructure, or facility-based processes, in this case and system associated with the generator control systems described herein. The data collected from the SCADA system 200 is web based. As such, HTML web pages 201 can be down loaded from components residing on the SCADA system 200 to the web server application 170. The web server application 170 can further include an exemplary web server 205 that is described further with respect to FIG. 3 herein. The web server application 170 can further include an application code manager (APP) 210 that runs control algorithms and is communicatively coupled to the web server 205. The APP 210 can be communicatively coupled to one or more external interfaces 215 for other external controllers, and further communicatively coupled to a compressed data log (CDL) 220, which is configured to store historical data in a data store 225 from the web server 205. A configuration file 221 can specify time increments in which to save the historical data. The APP 210 can be further communicatively coupled to a system data interface (SDI) 230 that communicates with programming tools for the web server application 170. In exemplary embodiments, the web server 205 can be communicatively coupled to a diagnostic system (DIAG) 235 that keeps a queue of diagnostic messages generated by the system 100. The web server 205 can further be communicatively coupled to an alarm manager (ALM) 240 that keeps a queue of alarms generated by the web server application 170. In exemplary embodiments, a command and event log (CEL) 245 keeps a log of commands and events issued in the web server application 170. The log can be kept in a data store 250. In addition, the CEL 245 can be configured to store the various commands and events via a configuration file 246. The CEL 245 is communicatively coupled to a sequence of events manager (SOE MGR) that tracks the sequence of events in the web server application 170. The CEL 245 is further communicatively coupled to Ethernet global data (EGD) 260, which is a module that communicates with the SCADA system 200 in real time to track the real time data. It will be appreciated that the CEL 245 is thus in communication with various components of the web server application 170. The web server 205 can further be coupled to a comment module 206 and symbol table 207 that include comments and meta-data for the various web variables in the web server application 205.

FIG. 3 illustrates a system level diagram of the web server 205 of FIG. 2, illustrating the exemplary process of the web server 205. As described herein, the exemplary systems and methods run the web server 205 in the background of the embedded controller 165 that is implemented to control the generator exciter 150, the generator 175, the static starter 180 and other components of the system 100. The embedded control 165 meets the real-time operational requirements of the excitation or static starter system. In exemplary embodiments, the web server 205 implements an interface for running external programs, software or gateways under an information server in a platform-independent manner, such as the common gateway interface (CGI), which defines how the web server 205 can delegate the generation of web pages to a stand-alone application such as an executable file. In exemplary embodiments, the stand-alone applications can be CGI-scripts and can be written in any programming language, such as scripting languages. In this way, the web server 205 can pass a web user's request to an application program and to receive data back to forward to the user. When the user requests a web page, the web server 205 sends back the requested page. However, when a user interacts on a web page, such as entering data, and sends it to the web server 205, it usually needs to be processed by an application program. The web server 205 passes the form information to a small application program that processes the data and may send back a confirmation message. The CGI provides a consistent way for data to be passed from the user's request to the application program and back to the user.

The web server 205, in general, handles a connection to the system 100 via an HTTP request from a browser (e.g., from the browser on the operator interface 105) beginning with a listen( )command 305 on a TCP socket, for example, followed by an accept( ) command 310. The web server 205 then creates a worker thread 325 to handle the connection. The worker thread 325 handles background tasks that do not compromise the critical generator tasks that are performed in addition to the subservient tasks. For example, tasks such as recalculation and background printing are tasks handled by the worker thread 325. In addition, the worker thread 325 creates an external shell 340 that processes CGI commands. The worker thread 325 further creates a process 335 to run the external shell 340. However, the typical process of locating the CGI command file, creating the shell and processing the command can compromise the critical generator tasks can be prohibitively expensive from a memory and CPU context switching perspective. For subservient tasks, the web server 205 implement the find CGI command file, create the shell and process the command pattern.

In exemplary embodiments, for generator critical tasks, the embedded controller 165 implements CGI in the web server 205 to interface with the generator components of the system 100 internally without the need to implement the listen( ) accept( ) create worker thread, find CGI command file, create the shell and process the command pattern. Instead, the web server 205 includes internal functions 320 that do not have to be created externally as with the listen( ) accept( ) create worker thread pattern. Instead, the internal functions 320 create the worker thread 325, CGI file calls 330 and process 335 to create internal CGI shells, that do not make calls to the external shall 340. The embedded controller 165 implements CGI for simplified internal calls. Internal CGI processing does not create separate processes associated with external calls such as disk I/O and context switches (e.g., via GCI Lite). External CGI calls include lengthy disk access reads to find appropriate CGI script or binary. In addition, at least one process consuming considerable memory is created with many context switches. In exemplary embodiments, when the web server 205 creates the worker thread 324 to service a particular connection, code associated with CGI decides whether a CGI call matches an appropriate internal call with a compare statement and proceeds to make the function call rather than creating a shell process to interpret or run CGI code.

In exemplary embodiments, the system 100 implements AJAX (Asynchronous JavaScript and XML) technology, which places the burden of computation on the operator interface section 105, which is the web client (the local operator station or HMI computer platform) rather than on the web server 205 and the embedded controller 165, which address the generator critical tasks. As such, the operator interface section 105, via AJAX, can retrieve data from the embedded controller 165 (and web server 205) asynchronously in the background without interfering with the display and behavior of web server application 170. The operator interface section 105 can retrieve data from the embedded controller 165 via an HttpRequest( ) object 350, which is an AJAX data call. The HttpRequest( ) object 350 retrieves data from the embedded controller 165 in XML format allowing all of the processing to be completed on the operator interface section 105 by traversing the DOM (Document Object Model) tree and interpreting and parsing the results as they become available. In AJAX, DOM is a cross-platform and language-independent convention for representing and interacting with objects in HTML, XHTML and XML documents, and can be accessed with JavaScript to dynamically display, and to allow the user to interact with the information presented. JavaScript and the HttpRequest( ) object 350 provide a method for exchanging data asynchronously between the web browser application 115 and web server 205 to avoid full page reloads. As such, the processing performed on the operator interface section 105 via AJAX does not burden the embedded controller 165 compared to JAVA or similar server side technologies. Furthermore, by implementing AJAX and the asynchronous HttpRequest( ) call, objects on the screen of the computer 110 are updated dynamically, as soon as the data is available giving a the used a smooth and fast user experience.

As such, the implementation of internal CGI calls and AJAX provides web based calls without affecting the ability of the embedded controller 165 to effectively perform its critical control functions. In addition, the internal functions 320 implement CGI calls as a local function within the context of the worker thread 325, which eliminated the context switch and memory overhead that would normally be associated with the creation of the external shell 340.

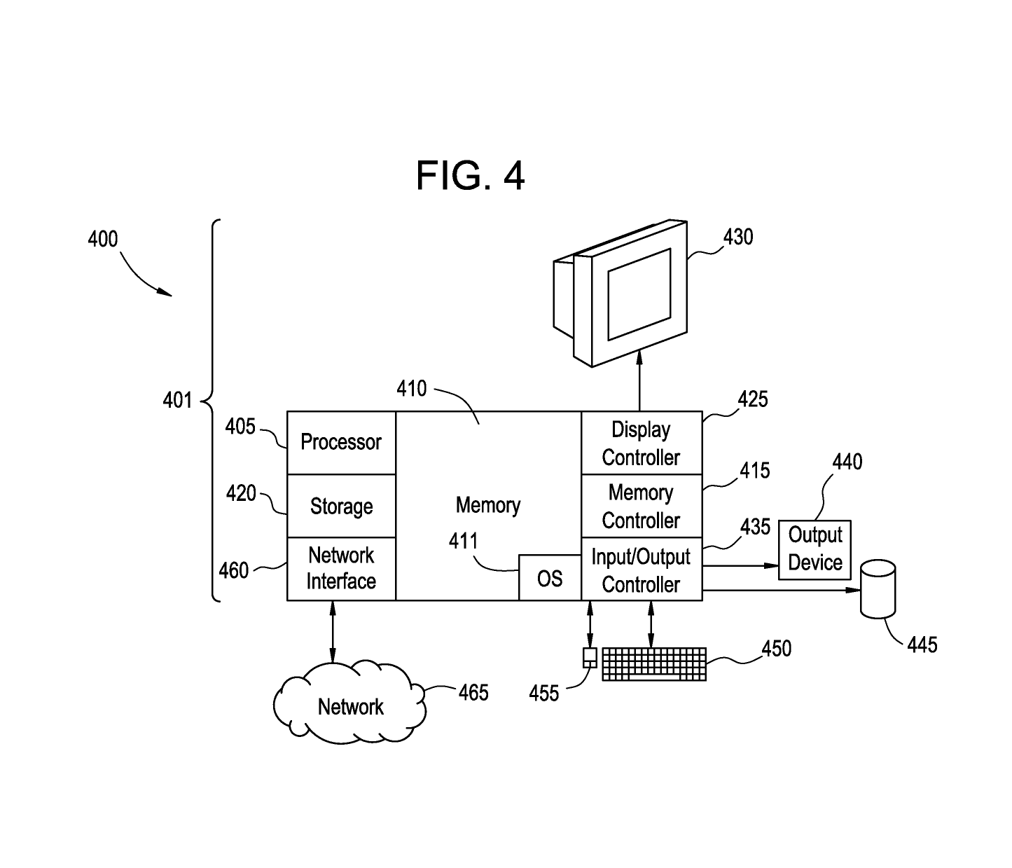

The operator interface 105 has been described as having a computer 110. Several types of computing devices can be implemented as the computer 110. One exemplary computing system is now described. FIG. 4 illustrates an exemplary embodiment of a system 400 for implementing a web-based operator control interface to generator control systems. The methods described herein can be implemented in software (e.g., firmware), hardware, or a combination thereof. In exemplary embodiments, the methods described herein are implemented in software, as an executable program, and is executed by a special or general-purpose digital computer, such as a personal computer, workstation, minicomputer, or mainframe computer. The system 400 therefore includes general-purpose computer 401.

In exemplary embodiments, in terms of hardware architecture, as shown in FIG. 4, the computer 401 includes a processor 405, memory 410 coupled to a memory controller 415, and one or more input and/or output (I/O) devices 440, 445 (or peripherals) that are communicatively coupled via a local input/output controller 435. The input/output controller 435 can be, but is not limited to, one or more buses or other wired or wireless connections, as is known in the art. The input/output controller 435 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor 405 is a hardware device for executing software, particularly that stored in memory 410. The processor 405 can be any custom made or commercially available processor, a central processing unit (CPU), an auxiliary processor among several processors associated with the computer 401, a semiconductor based microprocessor (in the form of a microchip or chip set), a macroprocessor, or generally any device for executing software instructions.

The memory 410 can include any one or combination of volatile memory elements (e.g., random access memory (RAM, such as DRAM, SRAM, SDRAM, etc.)) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 410 may incorporate electronic, magnetic, optical, and/or other types of storage media. Note that the memory 410 can have a distributed architecture, where various components are situated remote from one another, but can be accessed by the processor 405.

The software in memory 410 may include one or more separate programs, each of which comprises an ordered listing of executable instructions for implementing logical functions. In the example of FIG. 4, the software in the memory 410 includes the web-based operator control interface methods described herein in accordance with exemplary embodiments and a suitable operating system (OS) 411. The OS 411 essentially controls the execution of other computer programs, such the web-based operator control interface systems and methods as described herein, and provides scheduling, input-output control, file and data management, memory management, and communication control and related services.

The web-based operator control interface methods described herein may be in the form of a source program, executable program (object code), script, or any other entity comprising a set of instructions to be performed. When it is a source program, then the program needs to be translated via a compiler, assembler, interpreter, or the like, which may or may not be included within the memory 410, so as to operate properly in connection with the OS 411. Furthermore, the web-based operator control interface methods can be written as an object oriented programming language, which has classes of data and methods, or a procedure programming language, which has routines, subroutines, and/or functions.

In exemplary embodiments, a conventional keyboard 450 and mouse 455 can be coupled to the input/output controller 435. Other output devices such as the I/O devices 440, 445 may include input devices, for example but not limited to a printer, a scanner, microphone, and the like. Finally, the I/O devices 440, 445 may further include devices that communicate both inputs and outputs, for instance but not limited to, a network interface card (NIC) or modulator/demodulator (for accessing other files, devices, systems, or a network), a radio frequency (RF) or other transceiver, a telephonic interface, a bridge, a router, and the like. The system 400 can further include a display controller 425 coupled to a display 430. In exemplary embodiments, the system 400 can further include a network interface 460 for coupling to a network 465. The network 465 can be an IP-based network for communication between the computer 401 and any external server, client and the like via a broadband connection. The network 465 transmits and receives data between the computer 401 and external systems. In exemplary embodiments, network 465 can be a managed IP network administered by a service provider. The network 465 may be implemented in a wireless fashion, e.g., using wireless protocols and technologies, such as WiFi, WiMax, etc. The network 465 can also be a packet-switched network such as a local area network, wide area network, metropolitan area network, Internet network, or other similar type of network environment. The network 465 may be a fixed wireless network, a wireless local area network (LAN), a wireless wide area network (WAN) a personal area network (PAN), a virtual private network (VPN), intranet or other suitable network system and includes equipment for receiving and transmitting signals.

If the computer 401 is a PC, workstation, intelligent device or the like, the software in the memory 410 may further include a basic input output system (BIOS) (omitted for simplicity). The BIOS is a set of essential software routines that initialize and test hardware at startup, start the OS 411, and support the transfer of data among the hardware devices. The BIOS is stored in ROM so that the BIOS can be executed when the computer 401 is activated.

When the computer 401 is in operation, the processor 405 is configured to execute software stored within the memory 410, to communicate data to and from the memory 410, and to generally control operations of the computer 401 pursuant to the software. The web-based operator control interface methods described herein and the OS 411, in whole or in part, but typically the latter, are read by the processor 405, perhaps buffered within the processor 405, and then executed.

When the systems and methods described herein are implemented in software, as is shown in FIG. 4, the methods can be stored on any computer readable medium, such as storage 420, for use by or in connection with any computer related system or method.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In exemplary embodiments, where the web-based operator control interface methods are implemented in hardware, the web-based operator control interface methods described herein can implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

Technical effects include but are not limited to establishing a low-cost web based operator interface with an embedded controller of a generator system. As a web-based system, related software can be installed and maintained with decreased effort. In addition, the exemplary web-based systems and methods described herein reduce an amount of hardware needed in generator systems and shift processing burden from the embedded controller to the operator interface. In addition, the systems and methods described herein ease downloading of new web pages to the embedded controller. As such, where new control sub-systems are added to the generator control system (such as static or rotating field exciters and static starters) which needs to be controlled or monitored, web pages can be easily downloaded into the embedded controller without modifying existing setup or shutting down the generator control system. In addition, with web-based communication, multiple operator interfaces can concurrently fetch the data from the generator control system both locally and remotely. The web-based systems and methods described herein enable platform independence. As such, there is no software or hardware dependency as only web browser needs to run the web pages, which allows the system to run on scalable platforms to allow tradeoffs in cost and functionality.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A web-based operator control interface system, comprising:
an operator interface section including a web browser application;
at least one of a generator exciter section and a static starter section coupled to the operator interface section;
a generator coupled to the at least one of the generator exciter section and the static starter section; and
a web server application configured to receive processing requests from the web browser application, and further configured to internally process real-time system functions.

2. The system as claimed in claim 1 wherein the at least one of the generator exciter and the static starter section further comprises an embedded controller, wherein the web server application resides on the embedded controller.

3. The system as claimed in claim 1 wherein the web server application delegates generation of web pages for the web browser application via common gateway interface (CGI) calls.

4. The system as claimed in claim 3 wherein the real-time system functions are processed via CGI calls that are generated and processed internal to the web server application.

5. The system as claimed in claim 2 wherein non-real time computational functions are processed on the operator interface section by processing requests to and from the embedded controller via Asynchronous JavaScript and extensible markup language (XML) (AJAX) calls.

6. The system as claimed in claim 1 further comprising:
a power source coupled to the at least one of the generator exciter and the static starter section; and
a power converter coupled to the power source and configured to generate a voltage output for the generator,
wherein the web server application is further configured to process command inputs from the operator interface section, for the real-time generator functions of the generator related to the power converter.

7. The system as claimed in claim 6 wherein the power source is at least one of an alternating current (AC) power source and a direct current (DC) power source.

8. The system as claimed in claim 7 wherein the voltage output is a variable DC voltage output for the exciter section.

9. The system as claimed in claim 6 wherein the power source is an alternating current (AC) power source, and wherein the voltage output is a variable three-phase AC voltage output.

10. The system as claimed in claim 9 wherein the static starter section is configured to establish a rotation of the generator by starting the generator as a motor.

11. A web-based operator control interface method for a generator system, the method comprising:
receiving requests from a web browser application residing on an operator interface section of the generator system;
delegating generation of the requests for the web browser application via common gateway interface (CGI) calls;
internally processing requests in an embedded controller, related to real-time generator functions of the generator system via internal CGI functions; and
delegating non-real time tasks to the operator interface section.

12. The method as claimed in claim 11 further comprising processing command inputs from the operator interface section, for the real-time generator functions of the generator related to converting power to output voltage for the generator.

13. The method as claimed in claim 11 further comprising processing command inputs from the operator interface section, for the real-time generator functions of the generator related to establishing a rotation of the generator by starting the generator as a motor.

14. The method as claimed in claim 11 wherein the non-real time tasks are processed on the operator interface section by processing requests to and from the embedded controller.

15. The method as claimed in claim 14 wherein the requests to and from the embedded controller are processed via Asynchronous JavaScript and extensible markup language (XML) (AJAX) calls.

16. A computer program product including a non-transitory computer readable medium storing instructions for causing a computer to implement a web-based operator control interface method for a generator system, the method comprising:
receiving requests from a web browser application residing on an operator interface section of the generator system;
delegating generation of the requests for the web browser application via common gateway interface (CGI) calls;
internally processing requests in an embedded controller, related to real-time generator functions of the generator system via internal CGI functions; and
delegating non-real time tasks to the operator interface section.

17. The computer program product as claimed in claim 16 wherein the method further comprises processing command inputs from the operator interface section, for the real-time generator functions of the generator related to converting power to output voltage for the generator.

18. The computer program product as claimed in claim 16 wherein the method further comprises processing command inputs from the operator interface section, for the real-time generator functions of the generator related to establishing a rotation of the generator by starting the generator as a motor.

19. The computer program product as claimed in claim 16 wherein the non-real time tasks are processed on the operator interface section by processing requests to and from the embedded controller.

20. The computer program product as claimed in claim 19 wherein the requests to and from the embedded controller are processed via Asynchronous JavaScript and extensible markup language (XML) (AJAX) calls.
